(19) United States
(12) Patent Application Publication
(10) Pub. No.: US 2008/0077641 A1
(43) Pub. Date: Mar. 27, 2008

(54) SYSTEM AND METHOD FOR EDITING CONTRACT CLAUSES IN STATIC WEB PAGES

(75) Inventors: CHUNG-I LEE, Tu-Cheng (TW); HAI-HONG LIN, Shenzhen (CN); GANG PENG, Shenzhen (CN); XIN-LING LI, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/770,752

(22) Filed: Jun. 29, 2007

(30) Foreign Application Priority Data
Aug. 25, 2006 (CN) 200610062284.2

(51) Int. Cl. G06F 17/30; G06F 17/21

(52) U.S. Cl. 707/E17.009; 707/104.1

(57) ABSTRACT

A system for editing contract clauses in static web pages is provided. The system includes a database and a web server. The web server includes: a contract reading module for reading a contract in a static web page on the web server; a clause writing module for writing a selected clause to be edited into the database; a clause editing module for providing an edit textbox to edit the selected clause; and an updating module for updating database and the contract in the static web page after editing. A related method is also provided.

### BACKGROUND OF THE INVENTION

1. Field of the Invention

The present invention relates to systems and methods for editing contract clauses and, particularly, to a system and method for editing contract clauses in static web pages.

2. Description of Related Art

Along with the development of network security technology, electronic commerce has also been developing rapidly, which brings out widespread applications of electronic contracts. Presently, most electronic contract clauses provided in web pages are obtained through dynamic web page technology. Accordingly, edits of the electronic contract clauses are obtained through operations of dynamic web pages.

A dynamic web page is a template that displays specific information on a web site of a web server in response to queries. Most of the page content comes from a database connected to the web site. Webmasters can easily update the web site by editing the database, instead of having to edit hundreds of individual web pages. However, search engine spiders have a much tougher time with dynamic web pages, some get stuck if they can't supply information the web site needs to generate the web pages and others deliberately stay away from the dynamic web pages to avoid possibilities of getting trapped in the web sites. Due to two major problems with the web sites, when it comes to search engines: (1) dynamic web page does not exist when search engine Spiders are reading the web site; (2) the search engine spiders usually do not read character such as “?”, “%”, “$”, “#”, “&”, “*”, or “!”.

Comparing with a dynamic web page, a static web page is a document that practically exists on a web server. Content of a static web page is pre-formatted and doesn't change unless a webmaster changes the actual code to a HTML file of the static web page, which is done by: opening up the HTML file, editing the HTML file, saving the HTML file, and uploading it to the web server. All search engine spiders can index static web pages. Therefore, many dynamic web pages are converted to static web pages to provide more chances for the contract clauses to be read by the search engine spiders. However, there is no system and method for editing contract clauses in static web pages at present.

What is needed, therefore, is a system and method for editing contract clauses in static web pages.

### SUMMARY OF THE INVENTION

A system for editing contract clauses in static web pages according to a preferred embodiment is provided. The system includes a database and a web server. The web server includes: a contract reading module for reading a contract in a static web page on the web server; a clause writing module for writing a selected clause to be edited into the database; a clause editing module for providing an edit textbox to edit the selected clause; and an updating module for updating the database and the contract in the static web page after editing.

Another preferred embodiment provides a method for editing contract clauses in static web pages. The method includes: (a) reading a contract in a static web page on a web server; (a) writing a selected clause to be edited into a database; (a) providing an edit textbox for a user to edit the selected clause; and (d) updating the database and the contract in the static web page after editing.

Other advantages and novel features of the present invention will become more apparent from the following detailed description when taken in conjunction with the accompanying drawings.

### BRIEF DESCRIPTION OF THE DRAWINGS

FIG. 1 is a schematic diagram illustrating a system for editing contract clauses in static web pages according to a preferred embodiment;

FIG. 2 is a block diagram illustrating function modules of a web server in FIG. 1; and

FIG. 3 is a flowchart of a preferred method for editing contract clauses in static web pages.

### DETAILED DESCRIPTION OF THE PREFERRED EMBODIMENT

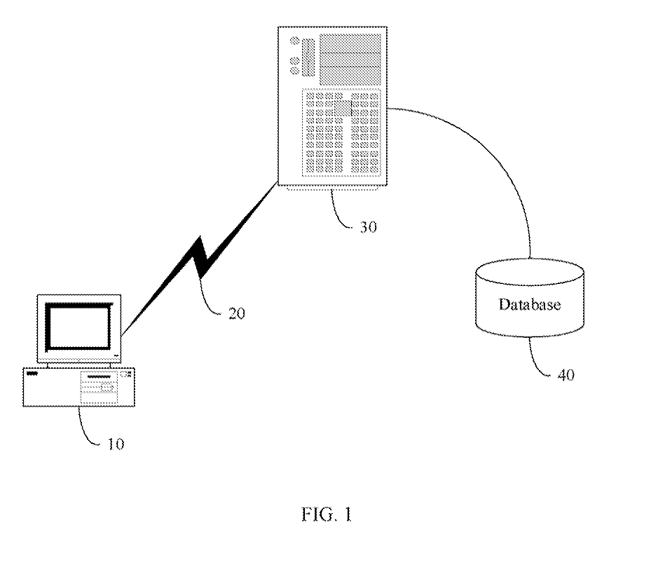

FIG. 1 is a schematic diagram illustrating a system for editing contract clauses in static web pages, according to a preferred embodiment. The system may include a plurality of client computers 10 (only one shown), a web server 30 connected to the client computer 10 via a network 20 and a database 40 connected to the web server 30.

The web server 30 is configured for storing static web pages, such as web pages in hypertext markup language (HTML) format, for reading contracts in the static web pages, writing selected contract clauses to be edited into the database 40, editing the selected contract clauses, and updating the contracts in the static web pages.

The database 40 is configured for storing the selected contract clauses.

The network 20 can be a local area network (LAN), a wide area network (WAN), a metropolis area network (MAN) or any other kind of network.

Each client computer 10 is programmed to provide an interactive user interface for users to accessing contracts in the static web pages on the web server 30.

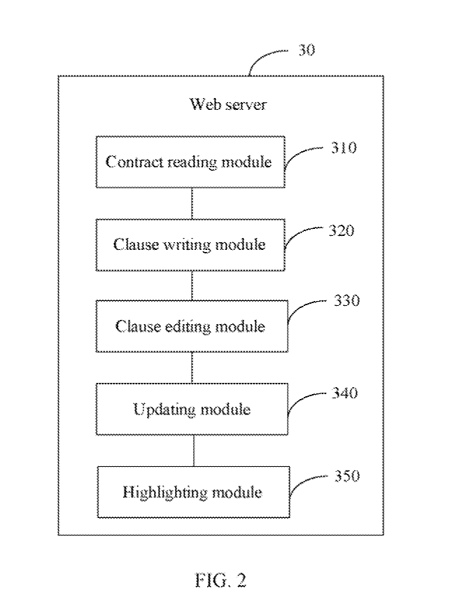

FIG. 2 is a block diagram illustrating function modules of the web server 30. The web server 30 typically includes: a contract reading module 310, a clause writing module 320, a clause editing module 330, an updating module 340, and a highlighting module 350.

The contract reading module 310 is programmed for reading a contract in a static web page. The clause writing module 320 is programmed for writing one or more selected clauses of the contract to be edited into the database 40. The clause editing module 330 is programmed for providing an edit textbox, for a contract manager (i.e. a lawyer) to edit the selected clause(s). The edit textbox provides the contract manager with buttons such as “amend”, “replace”, and “save” to deal with the selected clauses(s). The updating module 340 is programmed for updating the database 40 and the contract in the static web page, after editing. The highlighting module 350 is used for highlighting the edited clauses when users access the contract in the static web page.

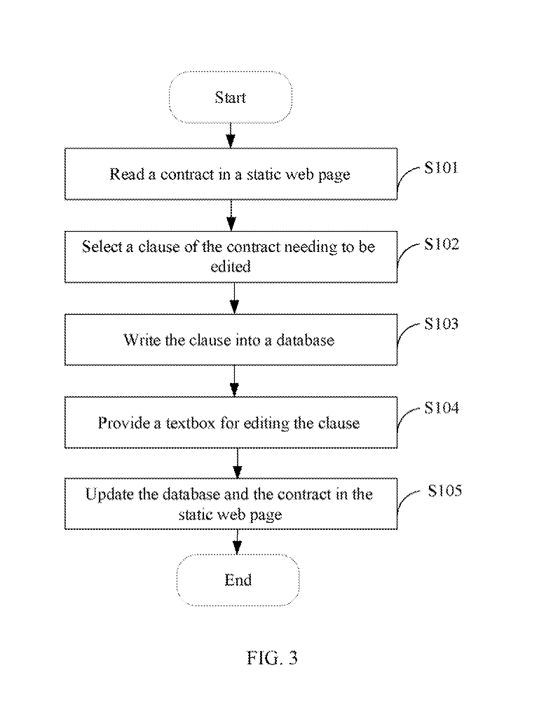

FIG. 3 is a flowchart of a preferred method for editing contract clauses in static web pages. First, in step S101, the contract reading module 310 reads a contract to be edited from a static web page, then in step S102, a contract manager (i.e. a lawyer) selects one or more clauses to be edited. In step S103, the writing module 320 writes the one or more selected clauses into the database 40. In step S104, the clause editing module 330 provides an edit textbox, for the contract manager to edit the one or more selected clauses, such as amending each of the one or more selected clauses or replacing a selected clause with a new added clause. After the contract manager finishes editing the one or more selected clauses, in step S105, the updating module 340 updates the contract in the static web page as well as the database 40. In step S106, the highlighting module 350 highlights the edited clauses in the static web pages.

Although the present invention has been specifically described on the basis of a preferred embodiment and preferred method, it is to be understood that the invention is not limited thereto, the disclosure is illustrative only and various changes or modifications may be made in detail, especially in matters of size, shape and arrangement of parts with in the principles of the invention to the full extent indicated by the broad general meaning of the terms in which the appended claims are expressed. Changes or modifications may be made to the embodiments and methods without departing from the scope and spirit of the invention.

What is claimed is:

1. A computer-based method for editing contract clauses in static web pages, comprising:
reading a contract in a static web page on a web server;
writing a selected clause to be edited into a database;
providing an edit textbox for a user to edit the selected clause; and updating the database and the contract in the static web page after editing.

2. The method as claimed in claim 1, further comprising:
highlighting the edited clause in the static web pages.

3. A system for editing contract clauses in static web pages comprising a web server and a database, the web server comprising:
a contract reading module for reading a contract in a static web page on the web server;
a clause writing module for writing a selected clause to be edited into the database;
a clause editing module for providing an edit textbox to edit the selected clause; and
an updating module for updating the database and the contract in the static web page after editing.

4. The system as claimed in claim 3, wherein the web server further comprises a highlighting module for highlighting the edited clause in the static web page.
